(19) United States
(12) Patent Application Publication
(10) Pub. No.: US 2011/0093310 A1
(43) Pub. Date: Apr. 21, 2011

(54) COMPUTER-READABLE, NON-TRANSITORY MEDIUM STORING A SYSTEM OPERATIONS MANAGEMENT SUPPORTING PROGRAM, SYSTEM OPERATIONS MANAGEMENT SUPPORTING METHOD, AND SYSTEM OPERATIONS MANAGEMENT SUPPORTING APPARATUS

(75) Inventors: Yukihiro Watanabe, Kawasaki (JP); Yasuhide Matsumoto, Kawasaki (JP); Kuniaki Shimada, Kawasaki (JP); Keiichi Oguro, Kawasaki (JP); Akira Katsuno, Kawasaki (JP); Yuji Wada, Kawasaki (JP); Masazumi Matsubara, Kawasaki (JP); Kenji Morimoto, Bunkyo (JP)

(73) Assignee: FUJITSU LIMITED, Kawasaki-shi (JP)

(21) Appl. No.: 12/954,325

(22) Filed: Nov. 24, 2010

Related U.S. Application Data
(63) Continuation of application No. PCT/JP2008/059728, filed on May 27, 2008.

(51) Int. Cl. G06Q 10/00

(52) U.S. Cl. 705/7.28

(57) ABSTRACT

Based on past failure sign appearance situations and past failure occurrence situations, failure occurrence probability which varies with a time elapse after failure sign appearance is calculated, and also, based on maintenance cost information of an operations management objective system, a short-term troubleshooting cost required for responding to a failure associated with the failure sign appeared in the system is calculated. Furthermore, based on the past failure sign appearance situations and the past failure occurrence situations, and also, the maintenance cost information and the failure occurrence probability, a short-term first preventive maintenance cost required for preventive maintenance of the failure associated with the failure sign, and also, the failure occurrence probability and a short-term second preventive maintenance cost for when preventive maintenance performance is postponed until next failure sign appearance, are calculated. Then, options in which the short-term first preventive maintenance cost, the short-term second preventive maintenance cost and the troubleshooting cost are associated with the failure occurrence probability, are prepared to be offered via an output device.

### TECHNICAL FIELD

The embodiment discussed herein is directed to a technology for supporting operations management in various types of systems, such as, information systems and the like.

### BACKGROUND ART

In operations management for an information system, statuses of various types of devices which are operations management objectives are monitored, and, for example, occurrence of a writing error in a recording medium is detected as an event. An event which does not directly lead to a system failure is recovered by retrying processing, and therefore, is called “a failure sign”, in order to differentiate it from the system failure. If a failure sign is neglected, a serious system failure may eventually occur, and therefore, an operation called “preventive maintenance”, such as backup of the recording medium or exchange thereof, may be performed when the failure sign appears. Furthermore, in a full duplicated system, services are not suspended even if the system failure occurs, and therefore, an operation called a “troubleshooting” for recovering from the failure may be performed when the system failure occurs.

The preventive maintenance has an advantage of improving system availability, but has a disadvantage of increasing an operational cost. On the other hand, the troubleshooting has a disadvantage of lowering the system availability, but has an advantage of suppressing the operational cost. Therefore, a system operations manager needs to judge, based on the operational cost and system failure occurrence probability, which of the preventive maintenance and the troubleshooting is to be adopted. Thus, as disclosed in Japanese Laid-open (Kokai) Patent Application Publication No. 2004-152017 (Patent Document 1), there has been proposed a technology for calculating a failure risk and a recovery cost of each site, based on a failure rate indicating failure occurrence frequency, probability of failure sign overlooking as a result that a failure sign is overlooked to lead a failure occurrence and cost damage at the failure occurrence, to support the decision of an equipment maintenance method.
Patent Document 1: Japanese Laid-open (Kokai) Patent Application Publication No. 2004-152017

### DISCLOSURE OF THE INVENTION

### Problems to be Solved by the Invention

The information system has characteristics in that failure sign appearance causes are variedly changed depending on service burdens, usage environments and the like. In this case, from the viewpoint of the operational cost, during the course of from the failure sign appearance to the system failure occurrence, it is desirable to consider a preventive maintenance cost at the failure sign appearance and the system failure occurrence probability at the failure sign appearance, to thereby judge whether or not the preventive maintenance is to be performed. However, in the conventionally proposed technology, since aging deterioration in parts has been regarded as a failure occurrence cause and, accordingly, the failure rate at each site has been fixed, calculation precisions of the preventive maintenance cost at the failure sign appearance and of the system failure occurrence probability at the failure sign appearance have been insufficient. Therefore, even if the preventive maintenance cost and the system failure occurrence probability are offered at the time when the failure sign appears, it has been difficult to objectively judge whether or not the preventive maintenance is to be performed at the time when the failure sign appears.

Therefore, in view of the conventional problems as described above, the present invention has as an object to provide a technology for offering system failure occurrence probability at failure sign appearance and a maintenance cost at the failure sign appearance, both of which are calculated based on past failure sign appearance situations, past failure occurrence situations, and maintenance cost information, to thereby support system operations management.

### Means for Solving the Problems

In the present system operations management supporting technology, past failure sign appearance situations and past failure occurrence situations are referred to, to thereby calculate failure occurrence probability which varies with a subsequent time elapse, for each failure sign appeared until failure occurrence after preventive maintenance or troubleshooting was performed. Furthermore, maintenance cost information for an operations management objective system is referred to, to thereby calculate a short-term troubleshooting cost required for responding to a failure which is associated with the failure sign that appeared in the operations management objective system. Furthermore, the past failure sign appearance situations, the past failure occurrence situations, and the maintenance cost information are referred to, to thereby calculate a short-term first preventive maintenance cost required for the preventive maintenance of the failure associated with the failure sign. At the same time, the failure occurrence probability for when preventive maintenance performance is postponed until the next failure sign appearance is calculated based on the failure occurrence probability of the failure sign according to the number of times until the failure sign appearance after the preventive maintenance or the troubleshooting was performed, in the failure occurrence probability of each failure sign, and also, a short-term second preventive maintenance cost of the preventive maintenance to be performed at the moment of the next failure sign appearance is calculated based on the short-term troubleshooting cost and the first preventive maintenance cost, and also, the failure occurrence probability for when the preventive maintenance performance is postponed until the next failure sign appearance. Then, options in which the short-term first preventive maintenance cost, the short-term second preventive maintenance cost and the troubleshooting cost are associated with the failure occurrence probability are prepared to be offered via an output device.

Thus, the failure occurrence probability and the short-term cost are dynamically calculated taking the past failure sign appearance situations and the past failure occurrence situations into consideration. Then, the options indicating the failure occurrence probability and the short-term cost in the case in which the preventive maintenance is performed at each of the moments of the current failure sign appearance, the next failure sign appearance and the failure occurrence, are prepared to be offered via the output device.

### EFFECT OF THE INVENTION

According to the above-described system operations management supporting technology, even in the case in which the present invention is applied to the information system in which the failure sign appearance causes are variedly changed depending on service burdens, usage environments and the like, it is possible to calculate the failure occurrence probability and the short-term cost with high precision.

Furthermore, an operations manager can refer to the options offered via the output device, to thereby grasp a risk and a cost in the case in which the preventive maintenance or the response is performed at each of the moments of the current failure sign appearance, the next failure sign appearance and the failure occurrence. Therefore, in the case in which operation policies are determined as “minimization of cost”, “minimization of out-of-service risk” and the like, the operations manager can refer to the offered information, to thereby objectively judge which of the preventive maintenance and the response is the best by eliminating subjective judgment. Furthermore, irrespective of the knowledge/experience of the operations manager, the response available to the failure sign appearance can be determined.

### BRIEF DESCRIPTION OF DRAWINGS

FIG. 1 is a configuration diagram of one embodiment of a system operations management supporting apparatus.

FIG. 2 is a block diagram illustrating a functional configuration of the system operations management supporting apparatus.

FIG. 3 is an explanatory diagram of a correspondence table.

FIG. 4 is an explanatory diagram of an event log.

FIG. 5 is an explanatory diagram of an incident log.

FIG. 6 is an explanatory diagram of equipment cost information contained in system configuration information.

FIG. 7 is an explanatory diagram of maintenance contract information contained in the system configuration information.

FIG. 8 is an explanatory diagram of server information contained in the system configuration information.

FIG. 9 is an explanatory diagram of service configuration information contained in the system configuration information.

FIG. 10 is an explanatory diagram of service price information contained in the system configuration information.

FIG. 11 is an explanatory diagram of SLA information contained in the system configuration information.

FIG. 12 is a flowchart for explaining troubleshooting information preparation processing.

FIG. 13 is a flowchart for explaining failure occurrence probability calculation processing.

FIG. 14 is an explanatory diagram of a former-half calculating method of failure occurrence probability.

FIG. 15 is an explanatory diagram of a latter-half calculating method of the failure occurrence probability.

FIG. 16 is an explanatory diagram of calculated failure occurrence probability.

FIG. 17 is an explanatory diagram of failure occurrence probability curves.

FIG. 18 is a flowchart for explaining troubleshooting cost calculation processing.

FIG. 19 is an explanatory diagram of a troubleshooting cost calculating method.

FIG. 20 is a flowchart for explaining preventive maintenance cost calculation processing.

FIG. 21 is an explanatory diagram of a preventive maintenance cost calculating method at the moment of current failure sign appearance.

FIG. 22 is an explanatory diagram of a preventive maintenance cost calculating method at the moment of next failure sign appearance.

FIG. 23 is a flowchart for explaining amount of loss calculation processing.

FIG. 24 is an explanatory diagram of an amount of loss calculating method.

FIG. 25 is a flowchart for explaining options preparation processing.

FIG. 26 is an explanatory diagram illustrating one example of options.

FIG. 27 is a flowchart for explaining information offering processing.

### DESCRIPTION OF THE REFERENCE SYMBOLS

10 System operations management supporting apparatus
10A Correspondence table
10B CMDB (Configuration Management Database)
10C Troubleshooting information preparing section
10D Failure occurrence probability calculating section
10E Troubleshooting cost calculating section
10F Preventive maintenance cost calculating section
10G Amount of loss calculating section
10H Options preparing section
10I Information offering section
20 Network
30 Operations management objective system
40 Failure sign information

### DESCRIPTION OF EMBODIMENT

Hereinafter, the present invention will be described in detail, referring to the appended drawings.

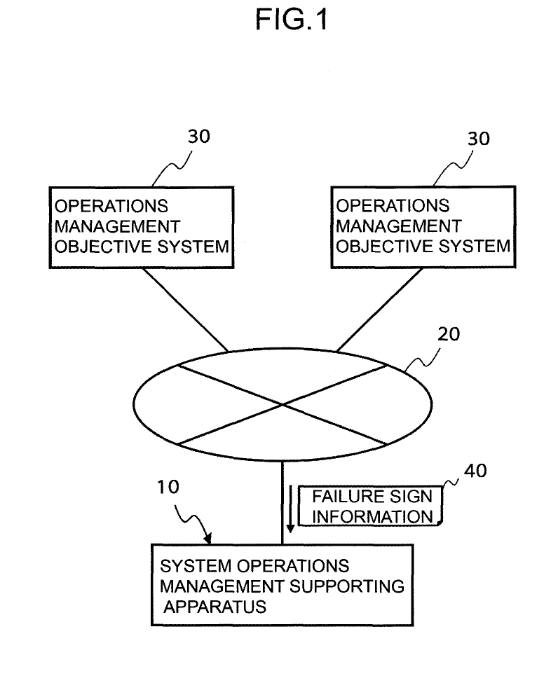

FIG. 1 illustrates one embodiment of a system operations management supporting apparatus which realizes the present invention.

A system operations management supporting apparatus 10 is connected to each operations management objective system 30, such as application servers providing various types of services or the like, via a network 20, such as the Internet, a LAN (Local Area Network), a WAN (Wide Area Network) or the like. In the operations management objective system 30, for example, S.M.A.R.T. (Self Monitoring Analysis and Reporting Technology) standardized in the hard disk industry, software which monitors a CPU (Central Processing Unit) utilization ratio, and the like, are previously installed. Then, in the operations management objective system 30, when a failure sign appearance of system failure is detected, failure sign information 40 containing failure sign contents and failure sign appearance sites is notified to the system operations management supporting apparatus 10.

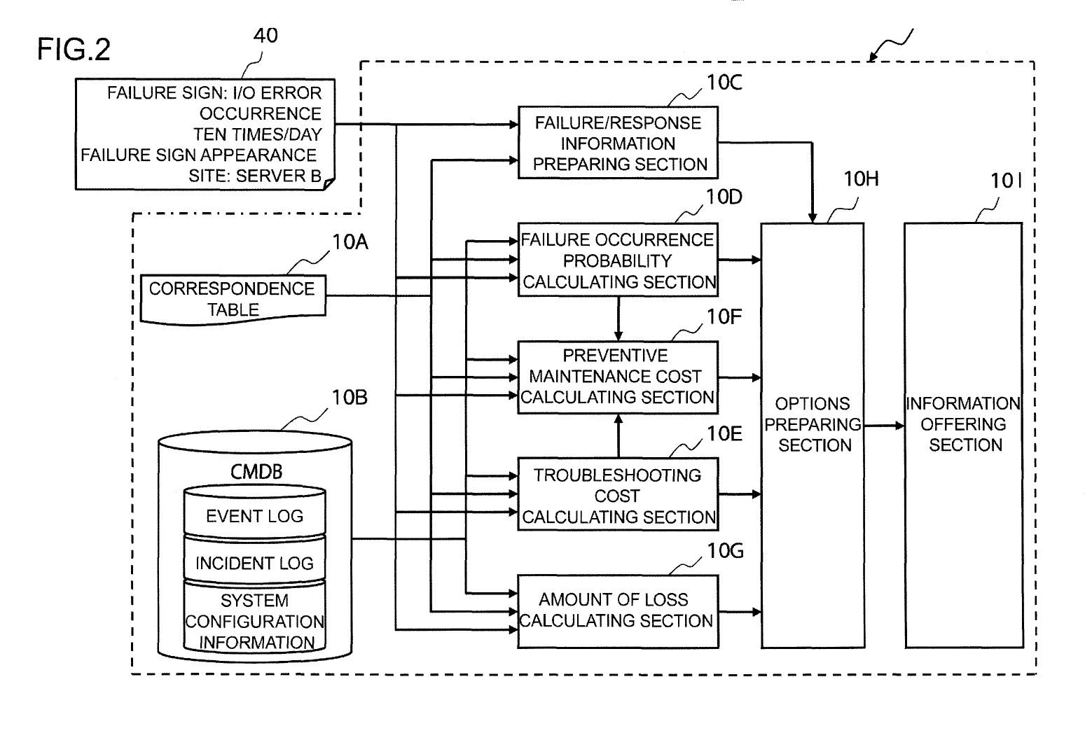

The system operations management supporting apparatus 10 is constructed by a computer which executes a system operations management supporting program. As illustrated in FIG. 2, the system operations management supporting apparatus 10 is provided with a correspondence table 10A and a CMDB 10B.

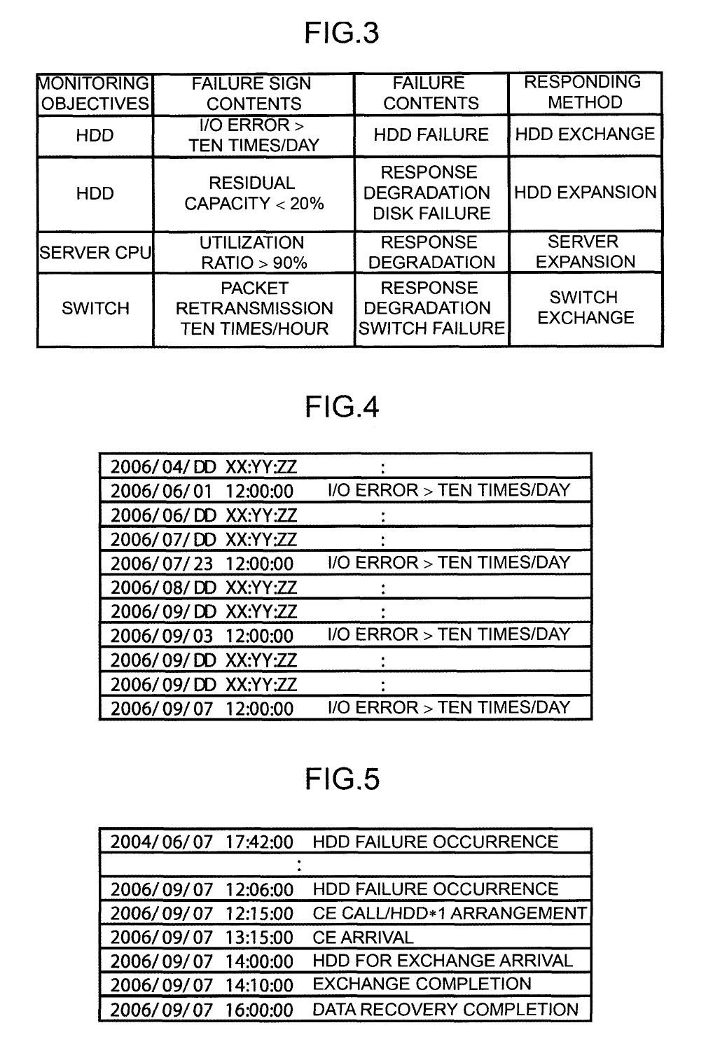

The correspondence table 10A is for associating a failure and a responding method with an event being a failure sign, and as illustrated in FIG. 3, is registered with monitoring objectives, the failure sign contents, failure contents and responding methods.

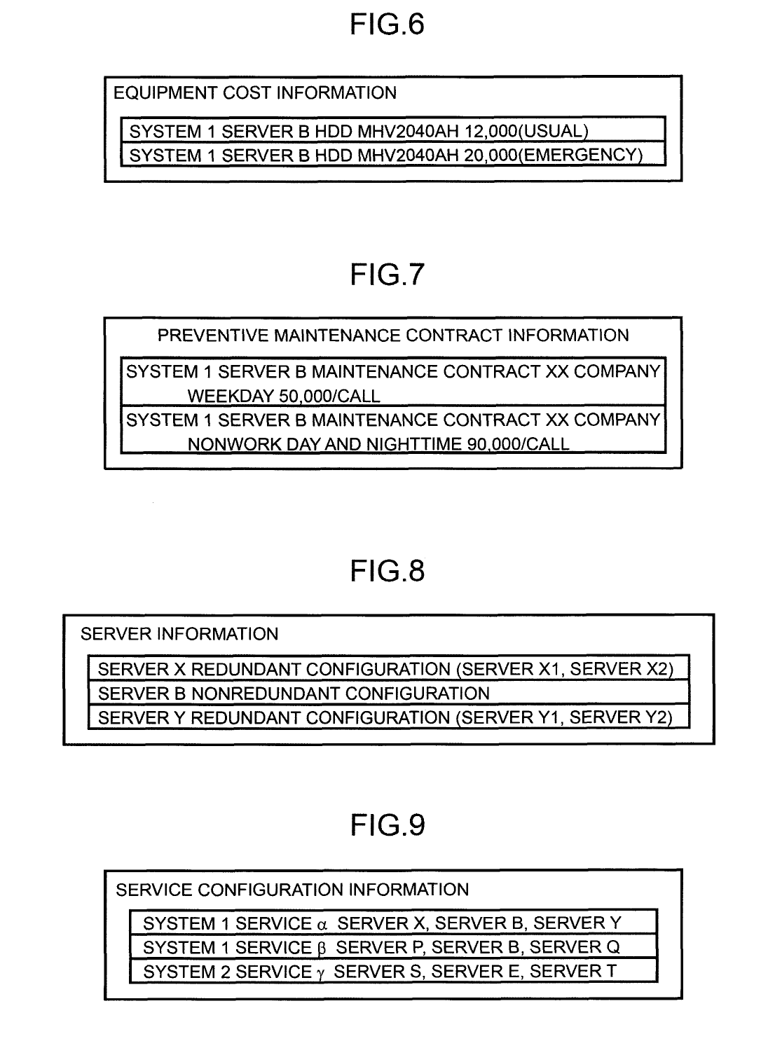

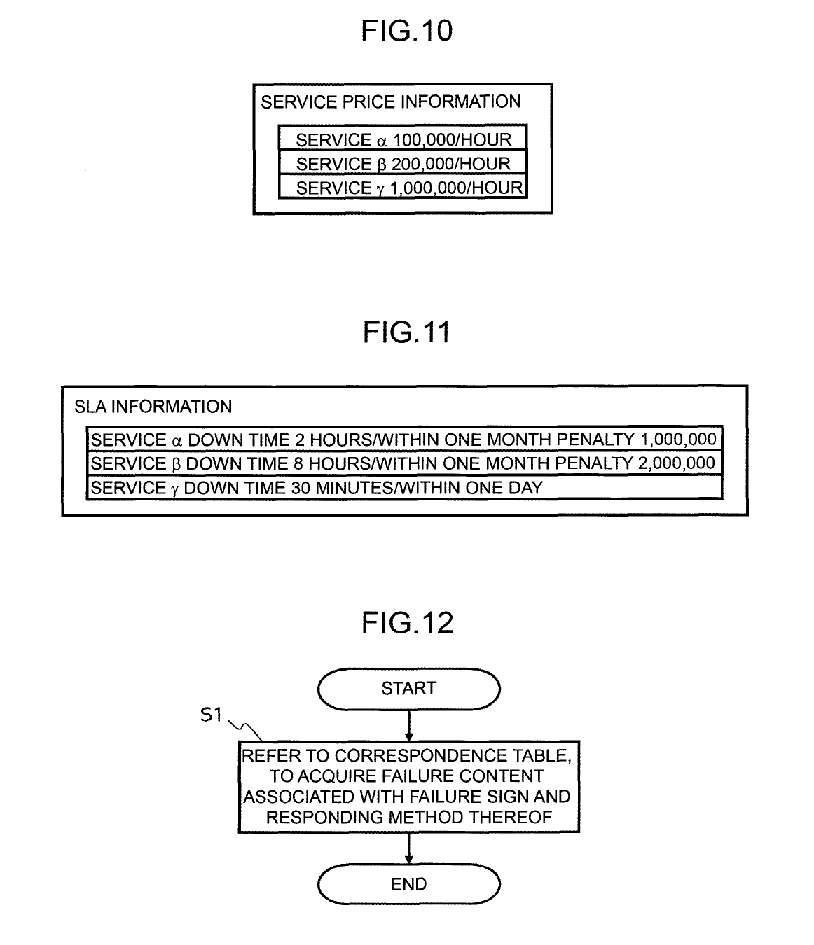

In the CMDB 10B, an event log, an incident log and system configuration information are stored for each operations management objective system 30. As illustrated in FIG. 4, in the event log, as past event records, dates of various events containing the failure signs, times thereof and contents thereof are registered. As illustrated in FIG. 5, in the incident log, as records of past failure occurrences and responses thereto, dates of the failures or the responses, times thereof, and contents thereof are registered. The system configuration information comprises equipment cost information, maintenance contract information, server information, service configuration information, service price information and SLA (Service Level Agreement) information (compensation information), as information for specifying equipments of the operations management objective system 30, software thereof and services thereof. As illustrated in FIG. 6, in the equipment cost information, purchase prices of various types of equipment making up the operations management objective system 30 are recorded. As illustrated in FIG. 7, in the maintenance contract information, maintenance contract information contracted with a maintenance company which performs maintenance of the operations management objective system 30, to be specific, a maintenance cost per one time corresponding to a maintenance time, is recorded. As illustrated in FIG. 8, in the server information, it is recorded whether or not each server making up the operations management objective system 30 is in a redundant configuration. As illustrated in FIG. 9, in the service configuration information, services provided by the operations management objective system 30 and servers which practically perform the services are recorded. As illustrated in FIG. 10, in the service price information, each price per unit time of each service, that is, each amount expectable for profit, is recorded. As illustrated in FIG. 11, in the SLA information, conditions and penalty charges to be compensated for a service provider company when each service is unable to be provided due to the system failure, is recorded. Here, maintenance cost information is made up by the equipment cost information and the maintenance contract information, and service value information is made up by the server information, the service configuration information and the service price information. Incidentally, the event log, the incident log and the system configuration information may be recorded not only in the CMDB 10B, but also in a typical database.

Furthermore, in the system operations management supporting apparatus 10, by executing the system operations management supporting program, a troubleshooting information preparing section 10C, a failure occurrence probability calculating section 10D, a troubleshooting cost calculating section 10E, a preventive maintenance cost calculating section 10F, an amount of loss calculating section 10G, an options preparing section 10H and an information offering section 10I are respectively realized.

In the troubleshooting information preparing section 10C, the correspondence table 10A is referred to, so that information representing the failure which is associated with the failure sign and the responding method thereof is prepared. In the failure occurrence probability calculating section 10D, the correspondence table 10A, and also, the event log in the CMDB 10B and the incident log therein, are referred to, so that failure occurrence probability increasing as time elapses is calculated based on past failure occurrence situations. In the troubleshooting cost calculating section 10E, the correspondence table 10A, and also, the incident log in the CMDB 10B and the system configuration information therein, are referred to, so that a troubleshooting cost required for failure recovery is calculated. In the preventive maintenance cost calculating section 10F, the correspondence table 10A, and also, the event log in the CMDB 10B, the incident log therein and the system configuration information therein, are referred to, so that a preventive maintenance cost required for preventive maintenance is calculated. In the amount of loss calculating section 10G, the correspondence table 10A, and also, the incident log in the CMDB 10B and the system configuration information therein, are referred to, so that an amount of loss due to out-of-service is calculated. In the options preparing section 10H, respective outputs from the troubleshooting information preparing section 10C, the failure occurrence probability calculating section 10D, the troubleshooting cost calculating section 10E, the preventive maintenance cost calculating section 10F and the amount of loss calculating section 10G, are input thereto, so that options to be offered to an operations manager are prepared. In the information offering section 10I, the options prepared in the option preparing section 10H are offered via various types of output devices, such as, a monitor, a printer and the like.

Here, failure information preparing means, failure occurrence probability calculating means, troubleshooting cost calculating means, preventive maintenance cost calculating means and amount of loss calculating means are realized, respectively, by the troubleshooting information preparing section 10C, the failure occurrence probability calculating section 10D, the troubleshooting cost calculating section 10E, the preventive maintenance cost calculating section 10F and the amount of loss calculating section 10G. Furthermore, options preparing means and information offering means are realized, respectively, by the options preparing section 10H and the information offering section 10I.

FIG. 12 illustrates troubleshooting information preparation processing which is executed in the troubleshooting information preparing section 10C at the moment of notification of the failure sign information 40.

In step 1 (in the drawing, to be abbreviated as “S1”, and the same rule will be applied to the subsequent steps), the correspondence table 10A is referred to, to thereby acquire the failure content which is associated with the failure sign specified by the failure sign information 40 and the responding method thereof. Explaining this process using a specific example, if the failure sign specified by the failure sign information 40 is “I/O error”, the correspondence table 10A is referred to, using “I/O error” as a key, to thereby acquire “HDD failure” and “HDD exchange” as the failure content which is associated with “I/O error” and the responding method thereof.

According to the above-described troubleshooting information preparation processing, when the failure sign information 40 is notified, the system failure which may occur in the future due to the failure sign specified by the failure sign information 40, and the responding method of the system failure, can be specified.

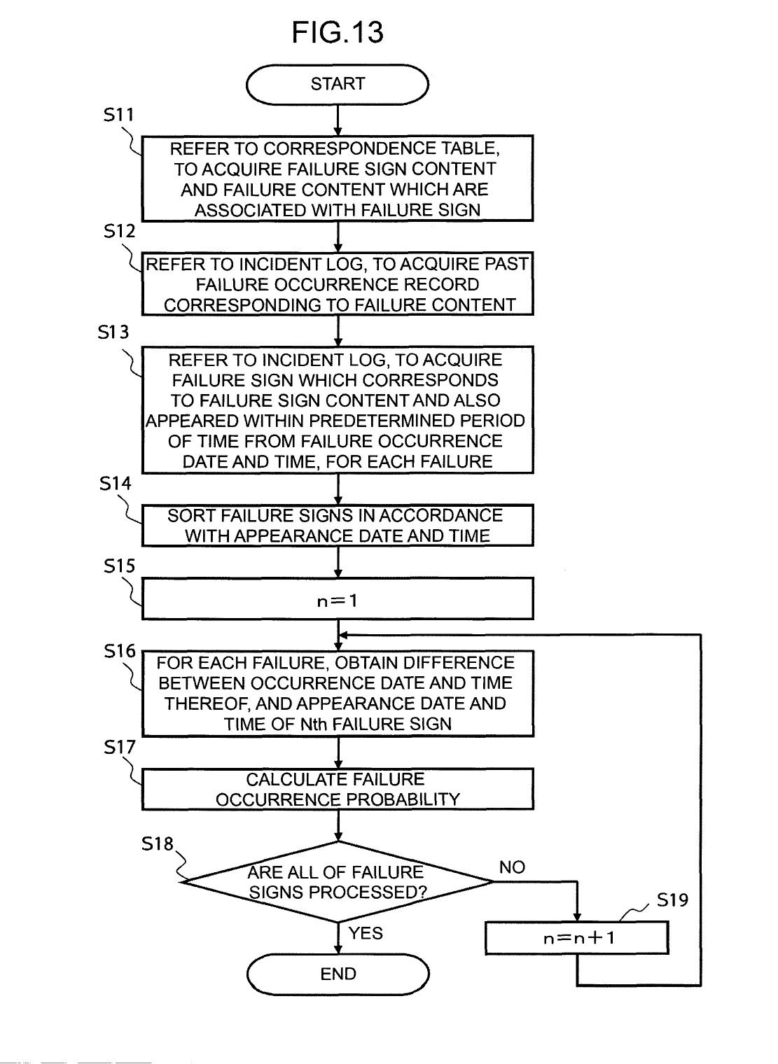

FIG. 13 illustrates failure occurrence probability calculation processing which is executed in the failure occurrence probability calculating section 10D at the moment of notification of the failure sign information 40.

In step 11, the correspondence table 10A is referred to, to thereby acquire the failure sign content and the failure content which are associated with the failure sign specified by the failure sign information 40. Explaining this process using a specific example, if the failure sign specified by the failure sign information 40 is “I/O error”, the correspondence table 10A is referred to, using “I/O error” as a key, to thereby acquire “I/O error>10 times/day” and “HDD failure” as the failure sign content and the failure content associated with “I/O error”.

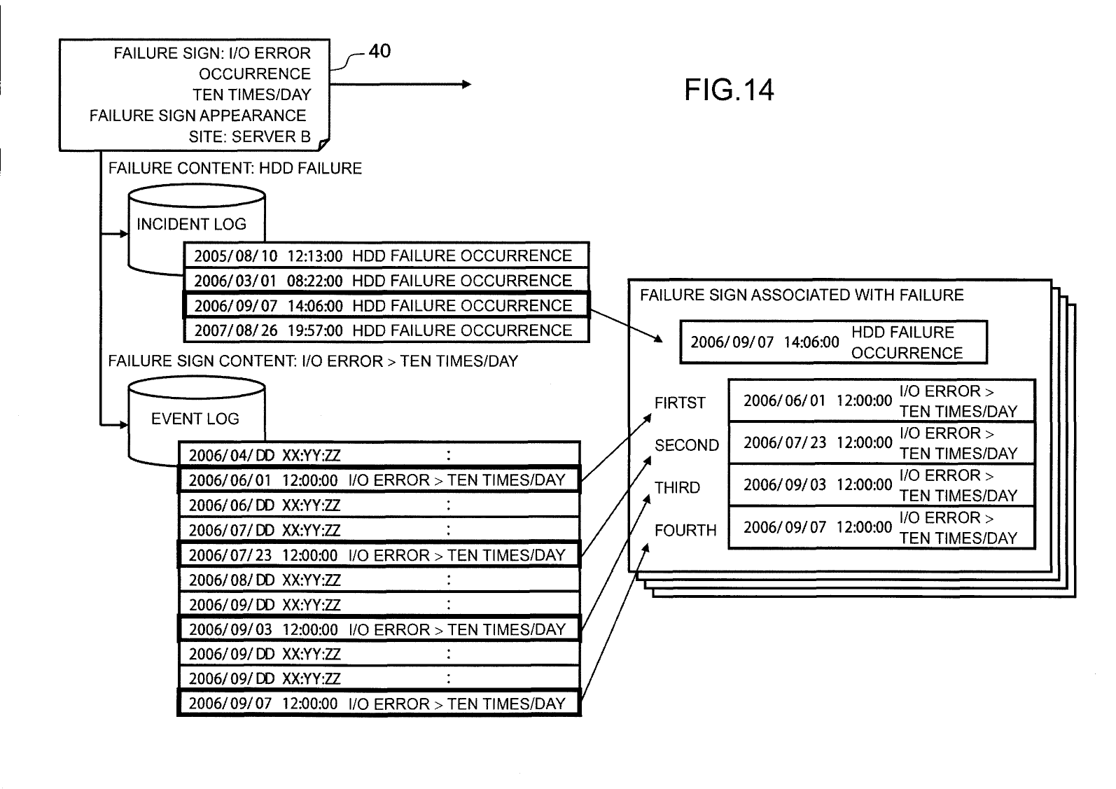

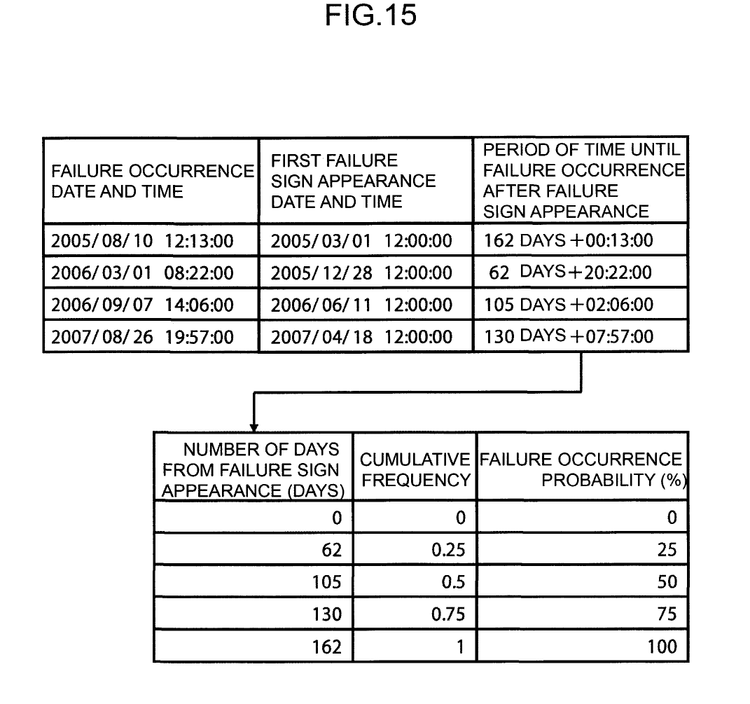

In step 12, the incident log in the CMDB 10B is referred to, to thereby acquire all of past failure occurrence records corresponding to the failure content, as illustrated in FIG. 14.

In step 13, the event log in the CMDB 10B is referred to, to thereby acquire all of the failure signs which correspond to the failure sign content, and also, appeared during a predetermined period of time (for example, six months) from failure occurrence date and time, for each failure specified by each failure occurrence record, as illustrated in FIG. 14.

In step 14, the failure signs are sorted using the appearance dates and times as a key, to be lined up in time series. Incidentally, instead of sorting the failure signs, the failure signs may be numbered in time series. Then, as illustrated in FIG. 14, each failure and the sorted failure sign are associated with each other, to be made “failure sign associated with the failure”.

In step 15, 1 is substituted into loop variable n.

In step 16, as illustrated in FIG. 15, for the failure sign associated with each failure, a period of time from the failure sign appearance to the failure occurrence, that is, a difference between the failure occurrence date and time, and the nth (the first in the figure) failure sign appearance date and time, is obtained.

In step 17, the periods of time from the failure sign appearance to the failure occurrence are sorted in ascending sequence, and as illustrated in FIG. 15, cumulative frequency corresponding to the number of days of the periods and the failure occurrence probability obtained by expressing the cumulative frequency in percentage are calculated.

In step 18, for the failure sign associated with each failure, it is judged whether or not all of the failure signs are processed. Then, if all of the failure signs are processed (Yes), the failure occurrence probability calculation processing is ended, whereas if all of the failure signs are not processed (No), the routine proceeds to step 19.

In step 19, after 1 is added to the loop variable n, the routine returns to step 16.

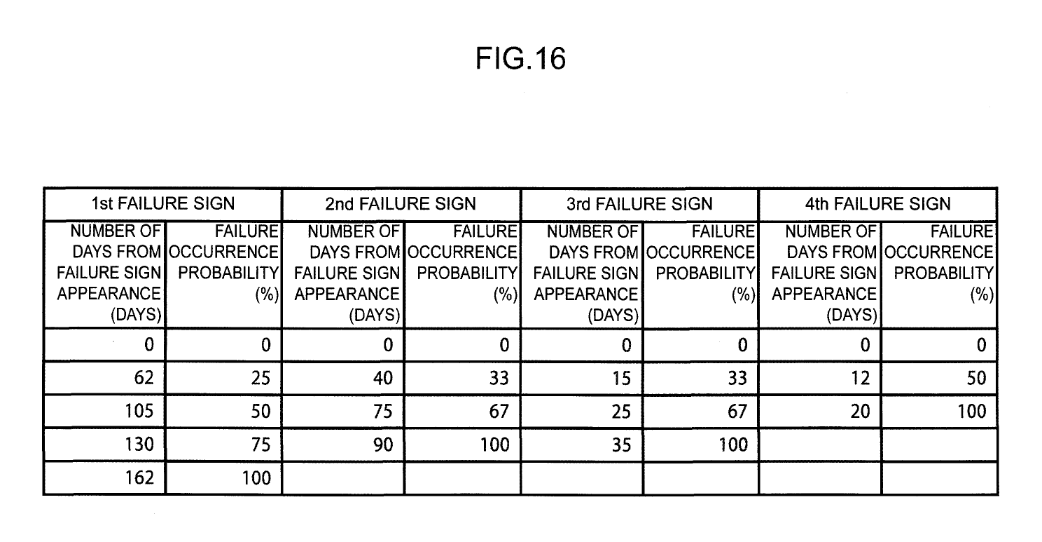

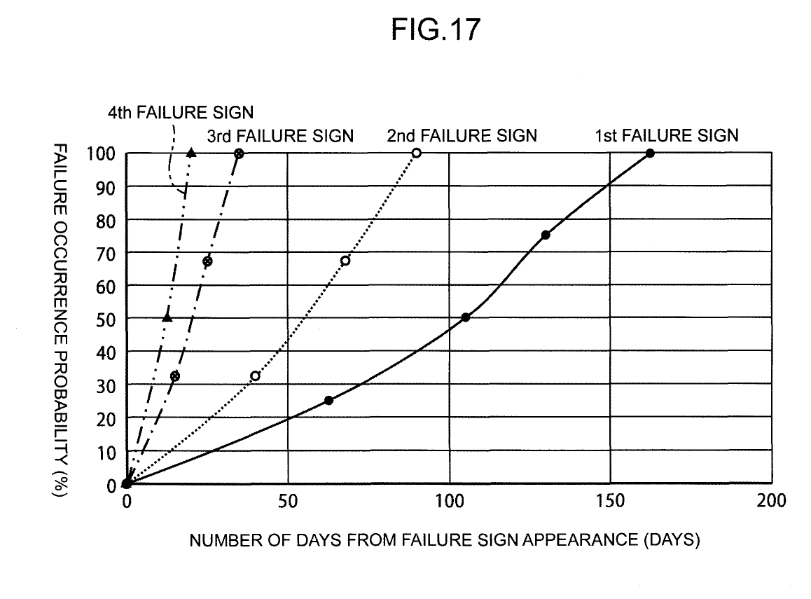

According to the failure occurrence probability calculation processing as described above, the past failure sign appearance situations and the past failure occurrence situations are referred to, so that the failure occurrence probability which varies with the time elapse after the nth failure sign appearance is calculated as illustrated in FIG. 16. Then, if the failure occurrence probability is plotted on a graph in which the number of days from the failure sign appearance is on a horizontal axis and the failure occurrence probability is on a vertical axis, failure occurrence probability curves as illustrated in FIG. 17 are obtained. Incidentally, the failure occurrence probability may be calculated by applying a known statistical strategy, based on the past failure sign appearance situations and the past failure occurrence situations.

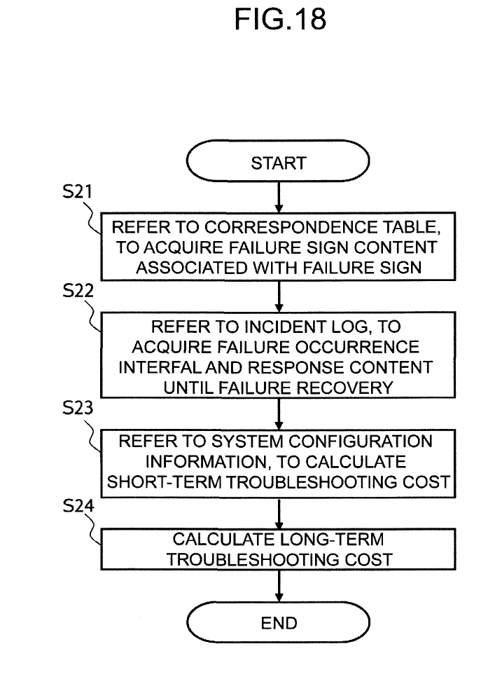

FIG. 18 illustrates troubleshooting cost calculation processing which is executed in the troubleshooting cost calculating section 10E at the moment of notification of the failure sign information 40.

In step 21, the correspondence table 10A is referred to, to thereby acquire the failure sign content associated with the failure sign specified by the failure sign information 40.

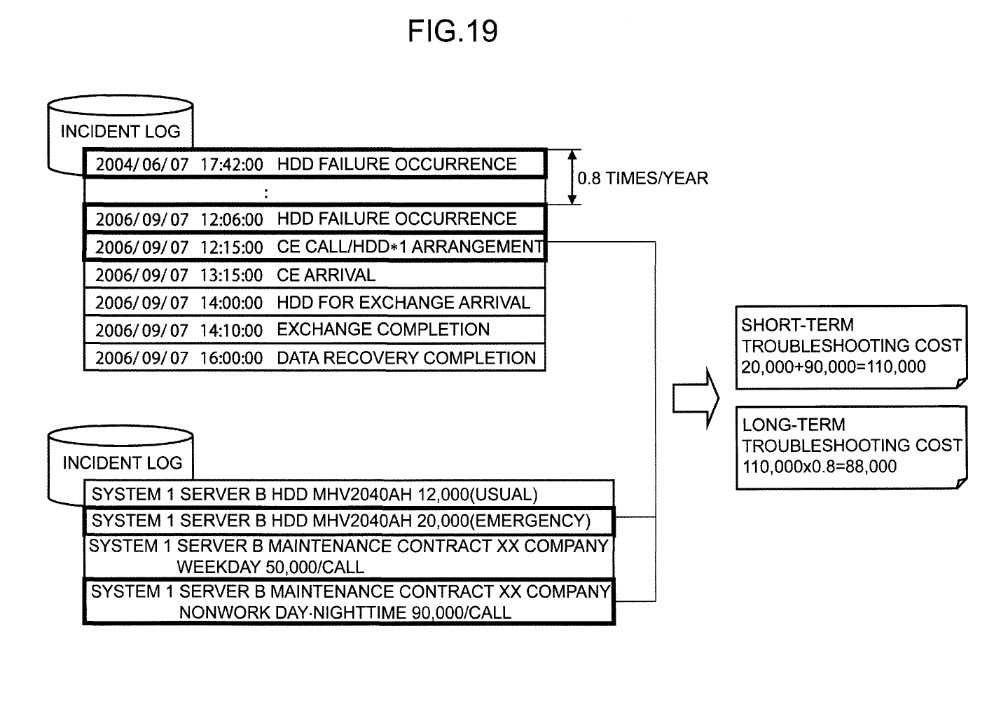

In step 22, the incident log in the CMDB 10B is referred to, to thereby acquire, respectively, a failure occurrence interval and a response content (troubleshooting result) until the failure recovery, as illustrated in FIG. 19.

In step 23, the equipment cost information and the preventive maintenance information which are contained in the system configuration information of the CMDB 10B are referred to, to thereby calculate a short-term troubleshooting cost for when a response the same as the past response content is performed, as illustrated in FIG. 19. Here, “short-term” means “only one time” (the same rule will be applied hereinafter).

In step 24, the short-term troubleshooting cost is multiplied by the failure occurrence period, to thereby calculate a long-term troubleshooting cost. Here, “long-term” means “over one year” (the same rule will be applied hereinafter).

According to the troubleshooting cost calculation processing as described above, the past failure occurrence situations and the system configuration information are referred to, and when the failure associated with the failure sign occurs, the short-term troubleshooting cost and the long-term troubleshooting cost required for the failure recovery are calculated. Therefore, a cost per one time and a cost per one year required for recovering from the failure occurrence can be obtained.

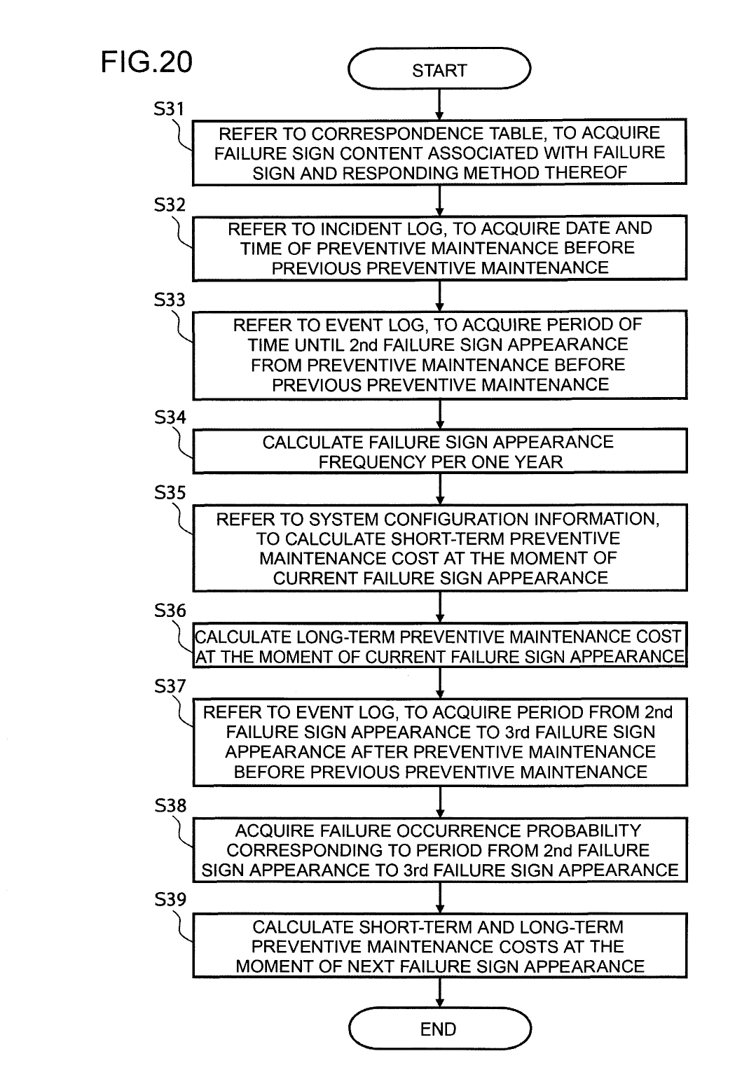

FIG. 20 illustrates preventive maintenance cost calculation processing which is executed in the preventive maintenance cost calculating section 10F when the failure sign information 40 is notified, the failure occurrence probability is calculated in the failure occurrence probability calculating section 10 and the troubleshooting cost is calculated in the troubleshooting cost calculating section 10E. Incidentally, in the preventive maintenance cost calculation processing to be described in the following, it is assumed that the current notification of the failure sign information is the second time. If the current notification is not the second time, “x” in “x-times” is to be appropriately replaced.

In step 31, the correspondence table 10A is referred to, to thereby acquire, respectively, the failure sign content which is associated with the failure sign specified by the failure sign information 40 and the responding method thereof.

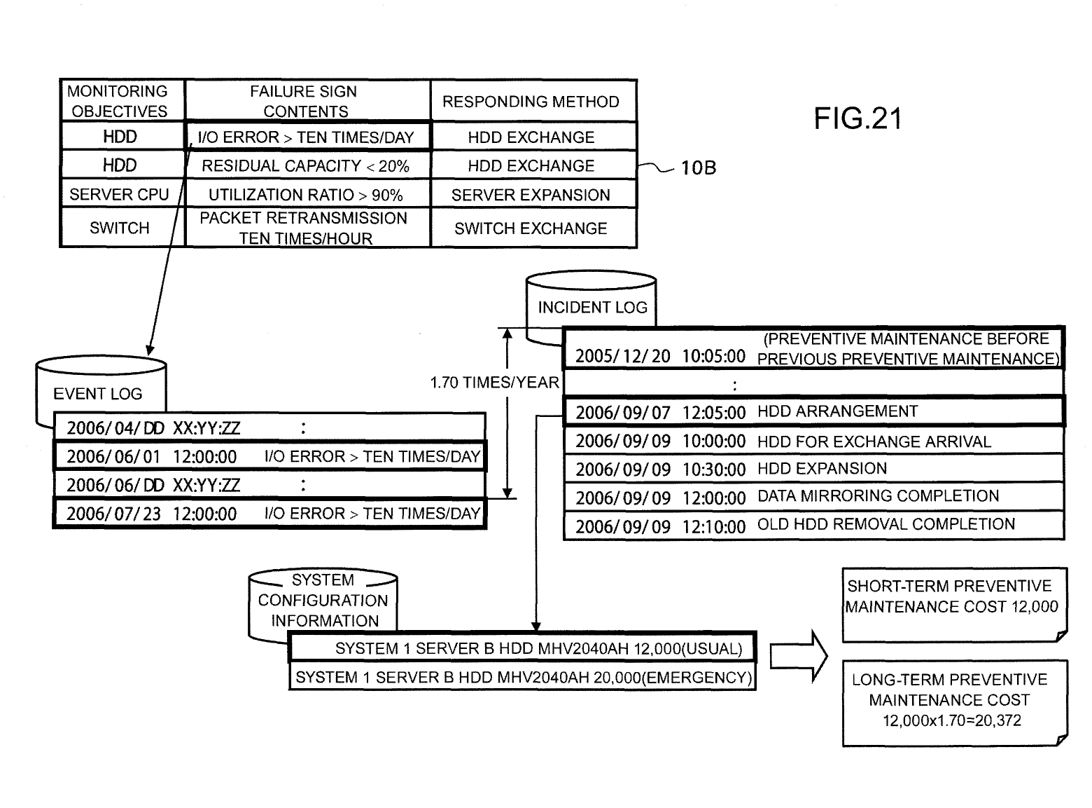

In step 32, the incident log in the CMDB 10B is referred to, to thereby acquire the date and time of the preventive maintenance before the previous preventive maintenance, which corresponds to the responding method, as illustrated in FIG. 21.

In step 33, the event log in the CMDB 10B is referred to, to acquire a period of time from the preventive maintenance before the previous preventive maintenance to the second failure sign appearance, in the failure signs corresponding to the failure sign contents, as illustrated in FIG. 21.

In step 34, the period of time from the preventive maintenance before the previous preventive maintenance to the second failure sign appearance is divided by the number of days in one year (365 days), to thereby calculate the failure sign appearance frequency per one year.

In step 35, the equipment cost information in the system configuration information of the CMDB 10B is referred to, to thereby calculate the short-term preventive maintenance cost for when the preventive maintenance the same as the previous preventive maintenance is performed.

In step 36, the short-term preventive maintenance cost is multiplied by the failure sign appearance frequency per one year, to thereby calculate the long-term preventive maintenance cost.

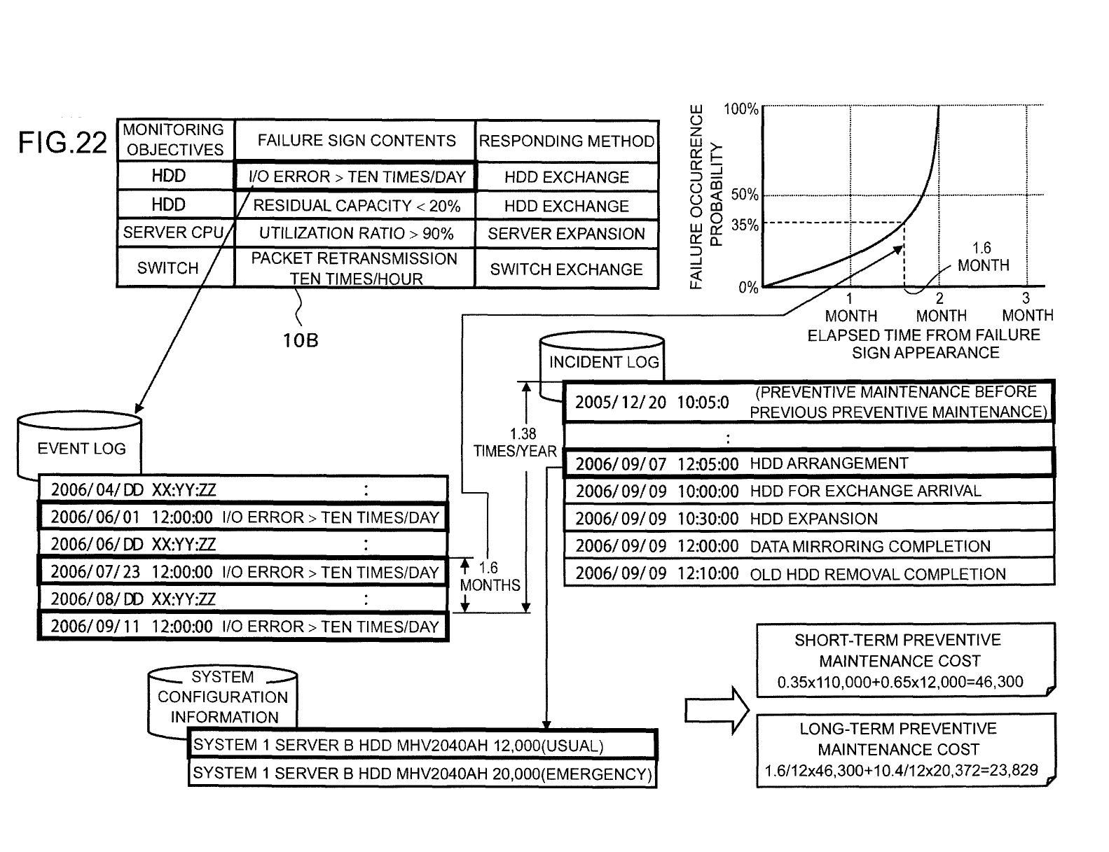

In step 37, the event log in the CMDB 10B is referred to, to thereby acquire a period of time from the second failure sign appearance to the third failure sign appearance after the preventive maintenance before the previous preventive maintenance is performed, as illustrated in FIG. 22.

In step 38, the second failure occurrence probability calculated in the failure occurrence probability calculating section 10D is referred to, to thereby acquire the failure occurrence probability corresponding to the period of time from the second failure sign appearance to the third failure sign appearance, as illustrated in FIG. 22.

In step 39, the short-term preventive maintenance cost and the long-term preventive maintenance cost for when the preventive maintenance is performed at the moment of the next failure sign appearance, are calculated using the following formulas. Incidentally, in the following formulas, the failure occurrence probability acquired in step 38 is to be called “probability” and the period of time from the second failure sign appearance to the third failure sign appearance is to be called “period of time”.

Short-term preventive maintenance cost at the moment of the next failure sign appearance=probability×troubleshooting cost+(1−probability)×short-term preventive maintenance cost at the moment of the current failure sign appearance

Long-term preventive maintenance cost at the moment of the next failure sign appearance=period of time/12×short-term preventive maintenance cost at the moment of the next failure sign appearance+(12−period of time)/12×long-term preventive maintenance cost at the moment of the current failure sign appearance

According to the preventive maintenance cost calculation processing as described above, the past failure sign appearance situations, the past failure occurrence situations and the system configuration information are referred to, so that the short-term preventive maintenance cost and the long-term preventive maintenance cost at the moment of the current and next failure signs appearance, are calculated. At this time, the long-term preventive maintenance cost at the moment of the next failure sign appearance is calculated, taking the failure occurrence probability of future system failure into consideration, and therefore, it is possible to improve calculation precision.

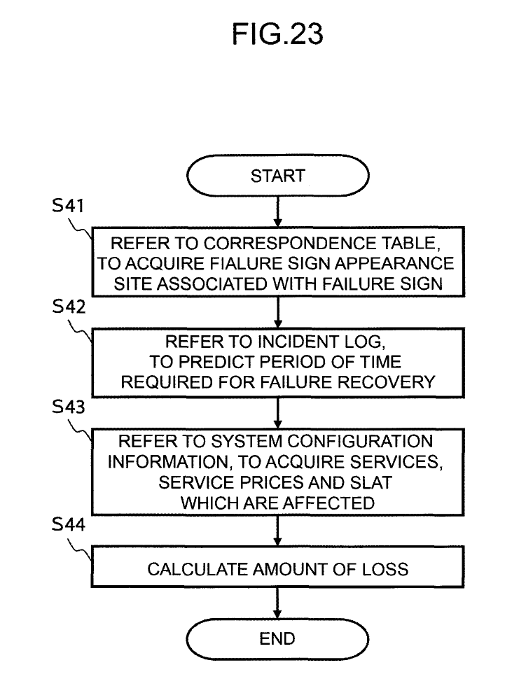

FIG. 23 illustrates amount of loss calculation processing which is executed in the amount of loss calculating section 10G at the moment of notification of the failure sign information 40.

In step 41, the correspondence table 10A is referred to, to thereby acquire a failure sign appearance site associated with the failure sign specified by the failure sign information 40.

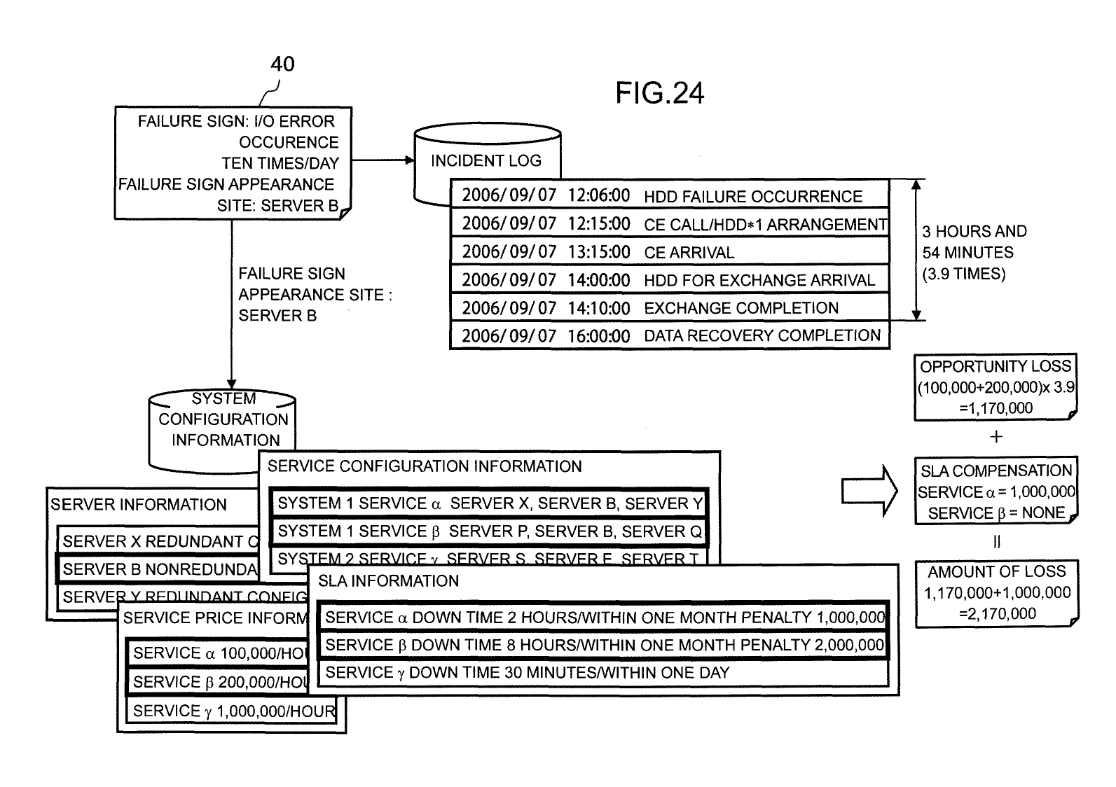

In step 42, the incident log in the CMDB 10B is referred to, to thereby predict a time (down time) required for the failure recovery based on the past troubleshooting results, as illustrated in FIG. 24.

In step 43, the server information, the service configuration information, the service price information and the SLA information which are contained in the system configuration information of the CMDB 10B, are referred to, to thereby acquire the services, the service prices and the SLA which are affected by the system failure occurred at the failure sign appearance site. Explaining this process by a specific example, referring to FIG. 24, when the failure sign appearance site is “a server B”, the service configuration information is referred to, to thereby specify that the affected services are “service α” and “service β”. Furthermore, the service price information is referred to, to thereby specify that a price of the service α is “100,000/hour” and a price of the service β is “200,000/hour”. Furthermore, the server information is referred to, and it is judged that there is a possibility of the SLA since the server B is in a non-redundant configuration, and the SLA information is read in.

In step 44, an amount of loss is calculated, based on the services, the service prices and the SLA which are affected by the down time and the system failure. Explaining this process by a specific example, referring to FIG. 24, in the case in which an expected down time is 3.9 hours and the prices of the services α and β are “100,000/hour” and “200,000/hour”, if the service a goes down for 2 hours or more, a penalty of 1,000,000 is charged, and furthermore, if the service β goes down for 8 hours or more, a penalty of 2,000,000 is charged. Therefore, an opportunity loss=(100,000+200,000)×3.9=1,170,000, and the SLA compensation=1,000,000. Then, by adding the opportunity loss with the SLA compensation, the amount of loss=2,270,000 is obtained.

According to the amount of loss calculation processing as described above, the past troubleshooting results and the system configuration information are referred to, to thereby calculate the opportunity loss and SLA compensation due to the out-of-service are calculated. Then, by adding the opportunity loss and the SLA compensation, a final amount of loss is obtained. Incidentally, needless to say, the SLA compensation is unnecessary in the case in which the services are provided by one's own system.

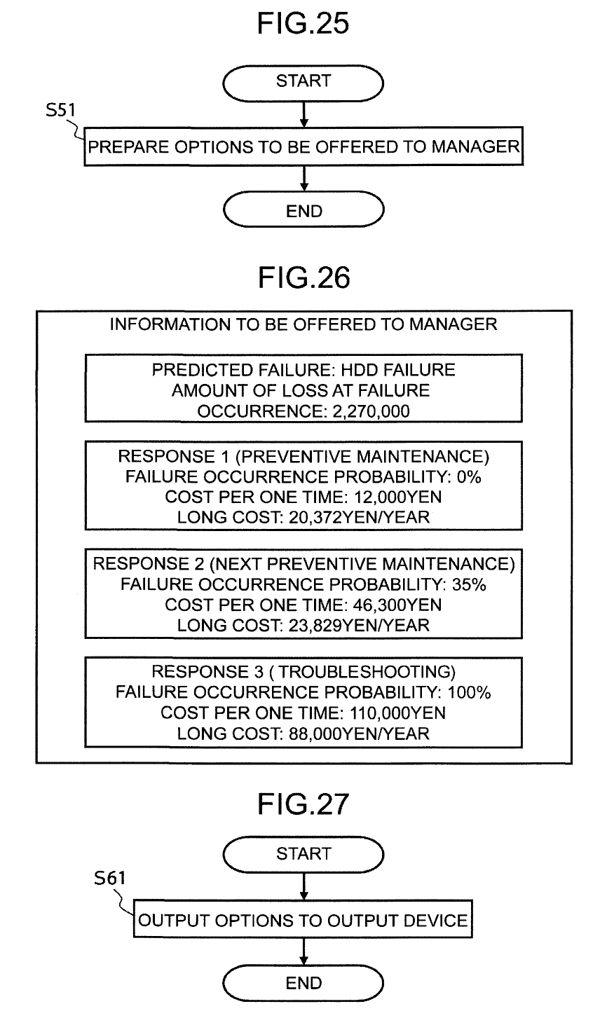

FIG. 25 illustrates options preparation processing which is executed in the options preparing section 10H at the moment of receiving respective outputs from the troubleshooting information preparing section 10C, the failure occurrence probability calculating section 10D, the troubleshooting cost calculating section 10E, the preventive maintenance cost calculating section 10F, and the amount of loss calculating section 10G.

In step 51, as information to be offered to the manager, as illustrated in FIG. 26, options comprising an expected failure, the amount of loss when the failure occurs and responses 1 to 3 are prepared. Here, the response 1 is the preventive maintenance to be performed at the moment of the current failure sign appearance, the response 2 is the preventive maintenance to be performed at the moment of the next failure sign appearance, and the response 3 is the troubleshooting. Furthermore, in each of the responses 1 to 3, the failure occurrence probability, the cost per one time (the short-term cost) and the long-term cost per one year (the long-term cost) are described.

According to the options preparation processing as described above, as the information to be offered to the operations manager, the options comprising the expected failure, the amount of loss which may result from the expected failure, and risks and costs in the responses 1 to 3, can be prepared.

FIG. 27 illustrates information offering processing which is executed in the information offering section 10I when the options are prepared in the options preparing section 10H.

In step 61, the options are output to an output device, such as a monitor, a printer or the like.

According to the information offering processing as described above, the options can be offered to the operations manager in a visually recognizable form.

According to this system operations management supporting apparatus, the failure occurrence probability, and also, the short-term and long-term costs are dynamically calculated, taking the past failure sign appearance situations and the failure occurrence situations into consideration. Therefore, even in the case in which the present invention is applied to an information system in which failure sign appearance causes are variedly changed depending on service burdens, usage environments and the like, it is possible to calculate with high precision the failure occurrence probability, and also, the short-term and long term costs.

Then, the options representing the failure occurrence probability, and also, the short-term and long term costs, are offered to the operations manager, when the responses are performed at the moments of the current failure sign appearance, the next failure sign appearance and the failure occurrence. At this time, the failure which may occur in the future due to the failure sign appearance and the amount of loss which may be charged as a result of this failure occurrence, are contained in these options. Therefore, it is possible for the operations manager to grasp the failure which occurs with the failure sign appearance, and the amount of loss as a result of this failure, and also, the risks and costs for when the responses are performed at the moments of the current failure sign appearance, the next failure sign appearance and the failure occurrence, by referring to the options offered via the output device. Consequently, in the case in which operation policies are determined as “minimization of cost”, “minimization of out-of-service” and the like, the operations manager can refer to the offered information, to thereby objectively judge whether the response is the best by eliminating subjective judgment. Furthermore, irrespective of the knowledge or experience of the operations manager, the response available to the failure sign appearance can be determined.

At this time, the amount of loss as a result of the out-of-service is additionally offered, and therefore, it is possible to determine the responses available at the moment of the failure sign appearance, considering whether or not the amount of loss is permissible. Furthermore, the amount of loss contains the compensation due to the out-of-service, and therefore, it is possible to additionally grasp a risk in the case in which an application server is rented to a service provider company. Furthermore, in each of the responses at the moments of the current failure sign appearance, the next failure sign appearance and the failure occurrence, the short-term cost and the long term cost are offered, and therefore, it is possible to determine the response available at the moment of the failure sign appearance, considering not only the short-term cost but also the long-term cost. In addition, since the content of the failure which may occur in the future due to the failure sign appearance is additionally offered, it is possible to judge whether or not this failure content is fatal.

Incidentally, in the present embodiment, the failure occurrence probability is calculated at the moment of notification of the failure sign information. However, the failure occurrence probability may be previously calculated at appropriate timing. Furthermore, the present invention is applicable not only to the information system but also to various systems as operations management objectives.

1. A computer-readable, non-transitory medium storing a system operations management supporting program for realizing, in a computer:
a failure occurrence probability calculating section that refers to past failure sign appearance situations and past failure occurrence situations which are stored in a database, to calculate failure occurrence probability which varies with a subsequent time elapse, for each failure sign that appeared until failure occurrence after preventive maintenance or troubleshooting was performed;
a troubleshooting cost calculating section that refers to maintenance cost information of an operations management objective system, which is stored in the database, to calculate a short-term troubleshooting cost required for responding to a failure which is associated with a failure sign appeared in the operations management objective system;
a preventive maintenance cost calculating section that refers to the past failure sign appearance situations, the past failure occurrence situations and the maintenance cost information which are stored in the database, to calculate a short-term first preventive maintenance cost required for the preventive maintenance of the failure associated with the failure sign, and also, to calculate the failure occurrence probability for when preventive maintenance performance is postponed until a next failure sign appearance, based on the failure occurrence probability of each failure sign according to number of times until the failure sign appearance after the preventive maintenance or the troubleshooting was performed, in the failure occurrence probability of each failure sign calculated in the failure occurrence probability calculating section, and furthermore, to calculate a short-term second preventive maintenance cost of the preventive maintenance to be performed at the moment of the next failure sign appearance, based on the short-term troubleshooting cost and the first preventive maintenance cost, and also, the failure occurrence probability for when the preventive maintenance performance is postponed until the next failure sign appearance;
an options preparing section that prepares options in which the short-term first preventive maintenance cost, the short-term second preventive maintenance cost and the troubleshooting cost are associated with the failure occurrence probability; and
an information offering section that offers the options prepared in the options preparing section via an output device.

2. A computer-readable, non-transitory medium storing a system operations management supporting program according to claim 1, for further realizing, in the computer;
an amount of loss calculating section that refers to past troubleshooting results and service price information of the operations management objective system, which are stored in the database, to calculate a period of time required for failure recovery after the failure occurrence, and also, to calculate an amount of loss as a result of services being unable to be provided for the period of time,
wherein the options preparing section adds the amount of loss calculated in the amount of loss preparing section to the options.

3. A computer-readable, non-transitory medium storing a system operations management supporting program according to claim 2,
wherein the amount of loss calculating section further refers to compensation information due to out-of-service of the operations management objective system, which is stored in the database, to calculate compensation as a result that the services are unable to be provided for the period of time required for the failure recovery after the failure occurrence, and also, to make the compensation to be contained in the amount of loss.

4. A computer-readable, non-transitory medium storing a system operations management supporting program according to claim 1,
wherein the troubleshooting cost calculating section further refers to the past failure occurrence situations stored in the database, to calculate failure occurrence frequency per one year, and also, to multiply the failure occurrence frequency per one year on the short-term troubleshooting cost, to thereby calculate a long-term troubleshooting cost;
the preventive maintenance cost calculating section further refers to the past failure sign appearance situations stored in the database, to calculate failure sign appearance frequency per one year and a period of time required for next failure sign appearance, and at the same time, to multiply the failure sign appearance frequency per one year on the short-term first preventive maintenance cost, to thereby calculate a long-term first preventive maintenance cost, and also, to calculate a long-term second preventive maintenance cost, based on the period of time required for the next failure sign appearance, the short-term second preventive maintenance cost and the long-term first preventive maintenance cost; and
the options preparing section adds the long-term troubleshooting cost calculated in the troubleshooting cost calculating section and the first and second preventive maintenance costs calculated in the preventive maintenance cost calculating section, to the options.

5. A computer-readable, non-transitory medium storing a system operations management supporting program according to claim 1, for further realizing, in the computer;
a failure information preparing section that refers to a correspondence table which associates the failure signs with failure contents, to acquire the failure content associated with the failure sign that appeared in the operations management objective system,
wherein the options preparing section adds the failure content acquired in the failure information preparing section to the options.

6. A system operations management supporting method for executing, in a computer, the steps of:
referring to past failure sign appearance situations and past failure occurrence situations which are stored in a database, to calculate failure occurrence probability which varies with a subsequent time elapse, for each failure sign that appeared until failure occurrence after preventive maintenance or troubleshooting was performed;
referring to maintenance cost information of an operations management objective system, which is stored in the database, to calculate a short-term troubleshooting cost required for responding to a failure which is associated with a failure sign that appeared in the operations management objective system;
referring to the past failure sign appearance situations, the past failure occurrence situations and the maintenance cost information which are stored in the database, to calculate a short-term first preventive maintenance cost required for the preventive maintenance of the failure associated with the failure sign, and also, to calculate the failure occurrence probability for when preventive maintenance performance is postponed until a next failure sign appearance, based on the failure occurrence probability of each failure sign according to number of times until the failure sign appearance after the preventive maintenance or the troubleshooting was performed, in the failure occurrence probability of each failure sign, and furthermore, to calculate a short-term second preventive maintenance cost of the preventive maintenance to be performed at the moment of the next failure sign appearance, based on the short-term troubleshooting cost and the first preventive maintenance cost, and also, the failure occurrence probability for when the preventive maintenance performance is postponed until the next failure sign appearance;
preparing options in which the short-term first preventive maintenance cost, the short-term second preventive maintenance cost and the troubleshooting cost are associated with the failure occurrence probability; and
offering the options via an output device.

7. A system operations management supporting method according to claim 6, for further executing, in the computer, the step of;
referring to past troubleshooting results and service price information of the operations management objective system, which are stored in the database, to calculate a period of time required for failure recovery after the failure occurrence, and also, to calculate an amount of loss as a result that services are unable to be provided for the period of time,
wherein the options preparing step adds the amount of loss to the options.

8. A system operations management supporting method according to claim 7,
wherein the amount of loss calculating step further refers to compensation information due to out-of-service of the operations management objective system, which is stored in the database, to calculate compensation as a result of the services being unable to be provided for the period of time required for the failure recovery after the failure occurrence, and also, to make the compensation to be contained in the amount of loss.

9. A system operations management supporting method according to claim 6,
wherein the troubleshooting cost calculating step further refers to the past failure occurrence situations stored in the database, to calculate failure occurrence frequency per one year, and also, to multiply the failure occurrence frequency per one year on the short-term troubleshooting cost, to thereby calculate a long-term troubleshooting cost;
the preventive maintenance cost calculating step further refers to the past failure sign appearance situations stored in the database, to calculate failure sign appearance frequency per one year and a period of time required for next failure sign appearance, and furthermore, to multiply the failure sign appearance frequency per one year on the short-term first preventive maintenance cost, to thereby calculate a long-term first preventive maintenance cost, and also, to calculate a long-term second preventive maintenance cost, based on the period of time required for the next failure sign appearance, the short-term second preventive maintenance cost and the long-term first preventive maintenance cost; and
the options preparing step adds the long-term troubleshooting cost and the first and second preventive maintenance costs, to the options.

10. A system operations management supporting method according to claim 6, for further executing, in the computer, the step of;
referring to a correspondence table which associates the failure signs with failure contents, to acquire the failure content associated with the failure sign appeared in the operations management objective system,
wherein the options preparing step adds the acquired failure content to the options.

11. A system operations management supporting apparatus comprising:
failure occurrence probability calculating means for referring to past failure sign appearance situations and past failure occurrence situations which are stored in a database, to calculate failure occurrence probability which varies with a subsequent time elapse, for each failure sign that appeared until failure occurrence after preventive maintenance or troubleshooting was performed;
troubleshooting cost calculating means for referring to maintenance cost information of an operations management objective system, which is stored in the database, to calculate a short-term troubleshooting cost required for responding to a failure which is associated with a failure sign that appeared in the operations management objective system;
preventive maintenance cost calculating means for referring to the past failure sign appearance situations, the past failure occurrence situations and the maintenance cost information which are stored in the database, to calculate a short-term first preventive maintenance cost required for the preventive maintenance of the failure associated with the failure sign, and also, to calculate the failure occurrence probability for when preventive maintenance performance is postponed until a next failure sign appearance, based on the failure occurrence probability of each failure sign according to number of times until the failure sign appearance after the preventive maintenance or the troubleshooting was performed, in the failure occurrence probability of each failure sign calculated by the failure occurrence probability calculating means, and furthermore, to calculate a short-term second preventive maintenance cost of the preventive maintenance to be performed at the moment of the next failure sign appearance, based on the short-term troubleshooting cost and the first preventive maintenance cost, and also, the failure occurrence probability for when the preventive maintenance performance is postponed until the next failure sign appearance;
options preparing means for preparing options in which the short-term first preventive maintenance cost, the short-term second preventive maintenance cost and the troubleshooting cost are associated with the failure occurrence probability; and
information offering means for offering the options prepared by the options preparing means via an output device.

12. A system operations management supporting apparatus according to claim 11, further comprising;
amount of loss calculating means for referring to past troubleshooting results and service price information of the operations management objective system, which are stored in the database, to calculate a period of time required for failure recovery after the failure occurrence, and also, to calculate an amount of loss as a result that services are unable to be provided for the period of time,
wherein the options preparing means adds the amount of loss calculated by the amount of loss preparing means to the options.

13. A system operations management supporting apparatus according to claim 12,
wherein the amount of loss calculating means further refers to compensation information stored in the database, due to out-of-service of the operations management objective system, to calculate compensation as a result of the services being unable to be provided for the period of time required for the failure recovery after the failure occurrence, and also, to make the compensation to be contained in the amount of loss.

14. A system operations management supporting apparatus according to claim 11,
wherein the troubleshooting cost calculating means further refers to the past failure occurrence situations stored in the database, to calculate failure occurrence frequency per one year, and also, to multiply the failure occurrence frequency per one year on the short-term troubleshooting cost, to thereby calculate a long-term troubleshooting cost;
the preventive maintenance cost calculating means further refers to the past failure sign appearance situations stored in the database, to calculate failure sign appearance frequency per one year and a period of time required for a next failure sign appearance, and furthermore, to multiply the failure sign appearance frequency per one year on the short-term first preventive maintenance cost, to thereby calculate a long-term first preventive maintenance cost, and also, to calculate a long-term second preventive maintenance cost, based on the period of time required for the next failure sign appearance, the short-term second preventive maintenance cost and the long-term first preventive maintenance cost; and
the options preparing means adds the long-term troubleshooting cost calculated by the troubleshooting cost calculating means and the first and second preventive maintenance costs calculated by the preventive maintenance cost calculating means, to the options.

15. A system operations management supporting apparatus according to claim 11, further comprising;
failure information preparing means for referring to a correspondence table which associates the failure signs with failure contents, to acquire the failure content associated with the failure sign that appeared in the operations management objective system,
wherein the options preparing means adds the failure content acquired by the failure information preparing means to the options.
